(19) United States
(12) Patent Application Publication
(10) Pub. No.: US 2023/0067713 A1
(43) Pub. Date: Mar. 2, 2023

(54) Vertical Takeoff and Landing Aeronautical Apparatus with a Folding Wing

(71) Applicant: Aerhart, LLC, Malibu, CA (US)

(72) Inventors: Kevin Burns, Malibu, CA (US); Victoria Hawkins, Mufreesboro, TN (US)

(73) Assignee: Aerhart, LLC, Malibu, CA (US)

(21) Appl. No.: 17/819,692

(22) Filed: Aug. 15, 2022

Related U.S. Application Data
(60) Provisional application No. 63/238,064, filed on Aug. 27, 2021.

(51) Int. Cl. B64C 29/00; B64C 3/56; B64C 39/02; B64D 27/26; B64D 29/02; B64C 25/32; B64D 31/00

(52) U.S. Cl. CPC B64C 29/0008; B64C 3/56; B64C 39/024; B64D 27/26; B64D 29/02; B64C 25/32; B64D 31/00

(57) ABSTRACT

An electric VTOL aeronautical apparatus is disclosed that has folding wings each having an inboard wing portion coupled to an outboard portion via a hinge. Folding wings are known to be used during flight, although using a motor to fold and unfold the wings. In the present disclosure, the motor with its concomitant weight and complication is obviated or reduced by making the rotational axis of the hinge such that end of the hinge on the leading edge of the wing is displaced more outboard and lower than the end of the hinge on the trailing edge to allow the wing to fold and unfold passively. When in forward flight, a folded wing has more of the underside of the wing facing the flow, which pushes the wing upward, i.e., unfolding the wing. When the aeronautical apparatus transitions to vertical flight, gravity pulls the wings downward into the folded position.

### FIELD

The present disclosure relates to vertical takeoff and landing (VTOL) aircraft, in particular aeronautical vehicles, commonly referred to as unmanned aerial vehicles (UAVs) or drones.

### BACKGROUND

Aircraft that can provide Urban Air Mobility (UAM) is a very active area of research around the world, with the electrical takeoff and landing (eVTOL) being of particular interest, such as that disclosed in commonly-assigned, published application US 2019/0225332A1. The ability of VTOL aircraft to land in a small area is key to its urban use. Commercially-viable eVTOLs have not yet been realized due to insufficient efficiency, meaning mission duration. Toward that end, U.S. Pat. No. 11,117,657 B2 discloses four wings to provide lift during forward flight and propellers that rotate between a position for forward flight and a position for vertical flight. It is well known to those skilled in the art, that greater lift leading to greater efficiency is facilitated by longer wingspan, such as used on glider planes. However, longer wings require more area in which to land, which complicates landing in urban spaces.

To address such a compromise, CN108327906A discloses an aircraft with “two folding wing sections . . . arranged at the two sides of the aircraft body.” Folding wings are well known in the prior art for storing aircraft or transporting aircraft more compactly e.g., transporting short-range aircraft in the hull of a ship. In those cases, the wings are folded upward or swept back and not meant to be flown in the folded configuration. The disclosed aircraft in CN108327906A operates in a forward flight mode with the wings fully extended and in vertical flight for landing with the wings folded downward, using servos (motors) to move the wings between the two positions. Servos add weight to the aircraft and draw energy from onboard batteries when actuated, both of which negatively impact efficiency.

### SUMMARY

To overcome drawbacks in the prior art, an aeronautical apparatus is disclosed that has a fuselage having a longitudinal axis, a lateral axis and a vertical axis, a first wing on a right side of the fuselage, and a second wing on a left side of the fuselage. The first and second wings each have an inboard wing portion and an outboard wing portion. The first and second wings are hinged such that an outboard tip of the outboard wing portion folds downward with respect to the hinge. The hinges are skewed with respect to the longitudinal axis of the fuselage. In some embodiments, an end of the hinge located at the leading edge of the inboard wing portion is located farther away from a vertical plane containing the longitudinal axis of the fuselage and/or closer to a horizontal plane below the aeronautical apparatus than an end of the hinge that is located at the trailing edge of the inboard wing portion. By orienting the hinge on the wing angled with respect to the longitudinal axis of the aircraft, the wing can be unhinged for forward flight without the use of a servo or other actuator. Instead, lift forces are used to deploy the folding wing because the underside of the wing, when folded down faces more towards the oncoming air, thereby increasing its angle of attack and developing a force to cause it to unfold. In vertical flight there is no lift force so the wing will fold due to gravity or from the downward thrust of a propeller. An advantage of such a passive approach to folding and unfolding the wing is that it obviates a motor for providing this capability. Reducing the number of motors reduces the weight, complexity, and part count of the apparatus. Furthermore, eliminating such motors increases range because they are no load on the battery. These forces can be also used to assist a smaller, lighter, motor with folding and unfolding a wing. This remains advantageous in that mass is reduced, while still allowing for the smaller motor to perform less strenuous movements such as attitude control maneuvers in forward flight.

In some embodiments, the first and second hinges are rotationally damped with a first damper adjacent to the first hinge to provide the rotational damping of the first hinge and a second damper adjacent to the second hinge to provide the rotational damping of the second hinge. Some embodiments include a first motor adjacent to the first damper and a second motor adjacent to the second damper. The first motor, when actuated, changes the amount of damping of the first damper; and the second motor, when actuated, changes the amount of damping of the second damper.

The aeronautical apparatus includes: a first nacelle coupled to the inboard portion of the first wing and a second nacelle coupled to the inboard portion of the second wing. The aeronautical apparatus includes: a first propeller motor disposed within the first nacelle, a second propeller motor disposed within the second nacelle, a first propeller coupled to the first propeller motor, and a second propeller coupled to the second propeller motor.

Some embodiments include: a third wing on the right side of the fuselage, the third wing being located upstream of the first wing; a fourth wing on the left side of the fuselage, the fourth wing being located upstream of the second wing; a third nacelle coupled to the third wing; a fourth nacelle coupled to the fourth wing; a third propeller motor disposed within the third nacelle; a fourth propeller motor disposed within the fourth nacelle; a third propeller coupled to the third propeller motor; and a fourth propeller coupled to the fourth propeller motor.

The aeronautical apparatus also includes: a first thrust angle motor located within the first nacelle and coupled to the first propeller motor and a second thrust angle motor located within the second nacelle and coupled to the second propeller motor. The first and second thrust angle motors each have an axis of rotation roughly parallel to the lateral axis.

In some embodiments, there is a first landing foot located at the tip of the first outboard wing portion and a second landing foot located at the tip of the second outboard wing portion. A vertical stabilizer is coupled to the fuselage that extends downwardly from the fuselage. There is a landing foot located at the tip of the vertical stabilizer.

In other embodiments a first landing pole is connected to a tip of the first outboard wing portion and a second landing pole connected to a tip of the second outboard wing portion.

In some embodiments, there is a first propeller motor coupled to the first wing, a second propeller motor coupled to the second wing, a first propeller coupled to the first propeller motor, a second propeller coupled to the second propeller motor, a third wing coupled to the fuselage on the same side of the fuselage as the inboard wing portion of the first wing, and a fourth wing coupled to the fuselage on the same side of the fuselage as the inboard wing portion of the second wing. The third wing is upstream of the first wing. The fourth wing is upstream of the second wing. A first nacelle is coupled to the third wing. A second nacelle is coupled to the fourth wing. A first thrust angle motor is disposed within the first nacelle. A second thrust angle motor is disposed within the second nacelle. An axis of rotation of the first and second thrust angle motors is substantially parallel with the lateral axis. A third propeller motor is coupled to the first thrust angle motor. A fourth propeller motor is coupled to the second thrust angle motor. A third propeller is coupled to the third propeller motor. A fourth propeller is coupled to the fourth propeller motor.

In some embodiments, the first hinge is constrained to rotate between a first angle and a second angle; the second hinge is constrained to rotate between a third angle and a fourth angle; the first angle is when a line through a center of the first outboard wing portion is parallel to a plane formed by the longitudinal and lateral axes; the second angle is when the line through the center of the first outboard wing portion is parallel to a plane formed by the longitudinal and vertical axes; the third angle is when a line through a center of the second outboard wing portion is parallel to the plane formed by the longitudinal and lateral axes; and the fourth angle is when the line through the center of the second outboard wing portion is parallel to the plane formed by the longitudinal and vertical axes.

Also included is a first latching mechanism associated with the first hinge to restrain the first outboard wing portion to remain at the first angle during forward flight and a second latching mechanism associated with the second hinge to restrain the second outboard wing portion to remain at the third angle during forward flight.

Other embodiments include: a first clasping mechanism associated with the first hinge to restrain the first outboard wing portion to remain at the second angle during landing and a second clasping mechanism associated with the second hinge to restrain the second outboard wing portion to remain at the fourth angle during landing.

In some embodiments, the axis of rotation of the first hinge is lower at a leading edge of the first inboard wing portion than a trailing edge of the first inboard wing portion and the axis of rotation of the second hinge is lower at a leading edge of the second inboard wing portion than a trailing edge of the second inboard wing portion.

The axis of rotation of the first hinge is closer to the fuselage at a trailing edge of the first inboard wing portion than a leading edge of the first inboard wing portion, and the axis of rotation of the second hinge is closer to the fuselage at a trailing edge of the second inboard wing portion than a leading edge of the second inboard wing portion, in some embodiments.

Some embodiments include: a first motor having a first rod and a second rod and a second motor having a third rod and a fourth rod. The second rod pivots with respect to the first rod when the first motor is actuated. The fourth rod pivots with respect to the third rod when the second motor is actuated. The first rod is coupled to the first inboard wing portion. The second rod is coupled to the first outboard wing portion. The third rod is coupled to the second inboard wing portion. The fourth rod is coupled to the second outboard wing portion. Any of the rods could alternatively be the casing of the motor. That is, when a change of a fold angle of one of the outboard wing portions is commanded by actuating the motor, the motor part (a rod or the motor frame) coupled to the outboard wing portion pivots with respect to the motor part coupled to the inboard wing portion to make such a change in the fold angle.

An electronic control unit (ECU) configured to communicate signals to the first motor and the second motor is included. The ECU determines a desired trajectory of the aeronautical apparatus based at least on user input. The ECU determines a desired fold angle for each of the first and second outboard wing portions. The ECU commands signals to each of the first motor and the second motor to achieve the desired fold angles for each of the first and second outboard wing portions.

In some embodiments, the inboard wing portions are connected to the fuselage with an anhedral configuration. In other embodiments, the inboard wing portions are connected to the fuselage with an dihedral configuration.

Also disclosed is an aeronautical apparatus having a fuselage having a longitudinal axis, a lateral axis and a vertical axis, a first and a second wing on a right side of the fuselage, and a third and a fourth wing on a left side of the fuselage. The first and third wings are fore wings. The second and fourth wings are aft wings. The second wing has a first inboard wing portion coupled to a first outboard wing portion via a first hinge. The fourth wing has a second inboard wing portion coupled to a second outboard wing portion via a second hinge. The first hinge allows the first outboard wing portion to pivot with respect to the first inboard wing portion. The second hinge allows the second outboard wing portion to pivot with respect to the second inboard wing portion. An axis of rotation of the first hinge is skewed with respect to the longitudinal axis. An axis of rotation of the second hinge is skewed with respect to the longitudinal axis.

The aeronautical apparatus may further include a first motor having a first rod and a second rod and a second motor having a third rod and a fourth rod. The second rod pivots with respect to the first rod when the first motor is actuated. The fourth rod pivots with respect to the third rod when the second motor is actuated. The first rod is coupled to the first inboard wing portion. The second rod is coupled to the first outboard wing portion. The third rod is coupled to the second inboard wing portion. The fourth rod is coupled to the second outboard wing portion. An electronic control unit (ECU) configured to communicate signals to the first motor and the second motor. The ECU determines a desired trajectory of the aeronautical apparatus based at least on user input. The ECU determines a desired fold angle for each of the first and second outboard wing portions. The ECU commands signals to each of the first motor and the second motor to achieve the desired fold angles for each of the first and second outboard wing portions.

In some embodiments, there is a first landing foot located at the tip of the first outboard wing portion and a second landing foot located at the tip of the second outboard wing portion.

Embodiments with motors to control the fold angle of the wings provide the capability to use the wings as control surfaces not previously realized. Although the complexity of having motors to fold the wings is a disadvantage, such complexity may be overcome by having fewer other control surfaces that lead to increased weight and drag on the aeronautical apparatus. Such ability to use the folding wings as control surfaces is facilitated by having the axis of the hinge that folds the wings not parallel (i.e., askew) with respect to the longitudinal axis of the fuselage. In alternative embodiments, the motors are not provided, which disallows using the wings as control surfaces as described herein. However, the complexity of the motors is obviated and the aerodynamic forces are utilized to passively control the folding of the wings.

### BRIEF DESCRIPTION OF THE DRAWINGS

FIGS. 1-3 is an embodiment of an aeronautical apparatus having a folding wing: with the wings fully open for forward flight in FIG. 1, with the wings folded for vertical flight in FIG. 2, and with the wings folded in a landed position in FIG. 3;

FIGS. 4 and 5 show an alternative embodiment having landing poles at the tips of the wings;

FIGS. 6-8 are details of the nacelle and folding wing portions of the embodiments in FIGS. 1-5;

FIGS. 9-11 show various angles associated with the design for the aeronautical apparatus of FIGS. 1-3;

FIGS. 12 and 13 show an alternative embodiment of a folding-wing aeronautical apparatus in which the fore pair of wings are fixed and the aft pair of wings are foldable;

FIGS. 14-16 show an alternative embodiment in which motors are provided to actuate the folding hinge for the purposes of control in forward flight;

FIG. 17 shows a front view of the aeronautical apparatus of FIGS. 1-3 where the folding wing portions are at asymmetrical fold angles; and

FIG. 18 illustrates the control steps involved in transition between forward and vertical flight for an embodiment of the folding-wing aeronautical apparatus in which the wings are folded and unfolded passively, i.e., due to aerodynamic forces, not motors.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

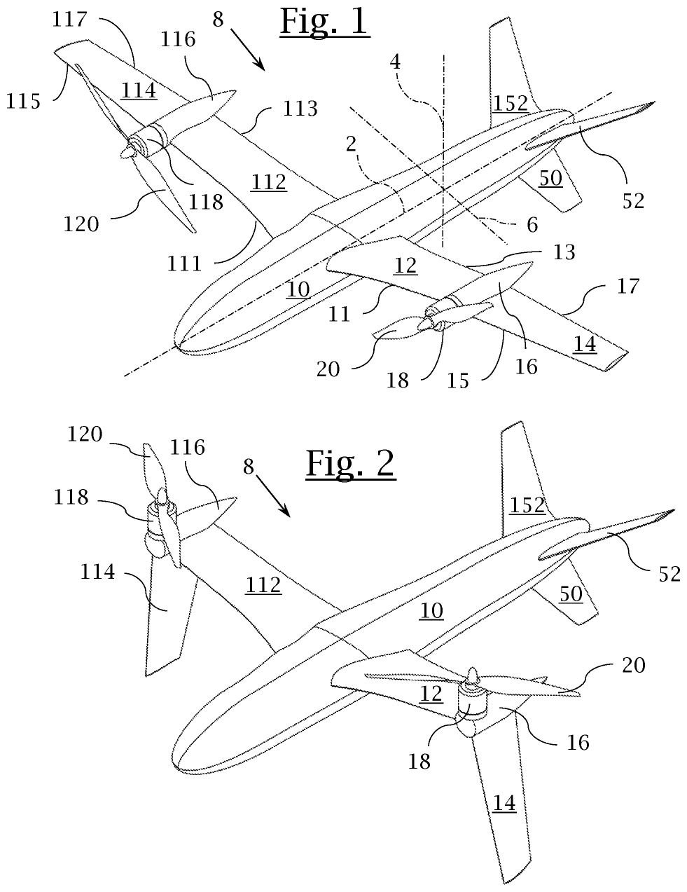

The embodiment in FIG. 1 shows an aeronautical apparatus 8 with a fuselage 10. A longitudinal axis 2 is along the axis of fuselage 10; a lateral axis 6 is across fuselage 10 and perpendicular to longitudinal axis 2; and, a vertical axis 4 is mutually perpendicular to both longitudinal axis 2 and lateral axis 6.

Folding wings are provided on either side of fuselage 10 with inboard portions 12 and 112 of the wings connected to fuselage 10. An outboard wing portion 14 of the wing is coupled to an inboard wing portion 12 via a nacelle 16; and similarly, an outboard wing portion 114 is coupled to inboard wing portion 112 via a nacelle 116. A propeller motor 18 is coupled to nacelle 16 with a propeller 20 coupled to propeller motor 18. Inboard wing portion 12 has a leading edge 11 and a trailing edge 13 and inboard wing portion 112 has a leading edge 111 and trailing edge 113. Outboard wing portion 14 has a leading edge 15 and a trailing edge 17 and outboard wing portion 114 has a leading edge 115 and a trailing edge 117.

Aft stabilizers 52 and 152 are coupled to the aft of fuselage 10. Aft stabilizers 52 and 152 are in a v-tail formation. Alternatively, aft stabilizers 52 and 152 are arranged horizontally, i.e., parallel to a plane formed by the lateral and longitudinal axes. Also connected to the aft of fuselage 10, in some embodiments, is a vertical stabilizer 50 that extends downwardly from fuselage 10. A tip of vertical stabilizer 50, in some embodiments, acts as a landing foot. Alternatively, a separate landing food is applied to the tip of vertical stabilizer 50.

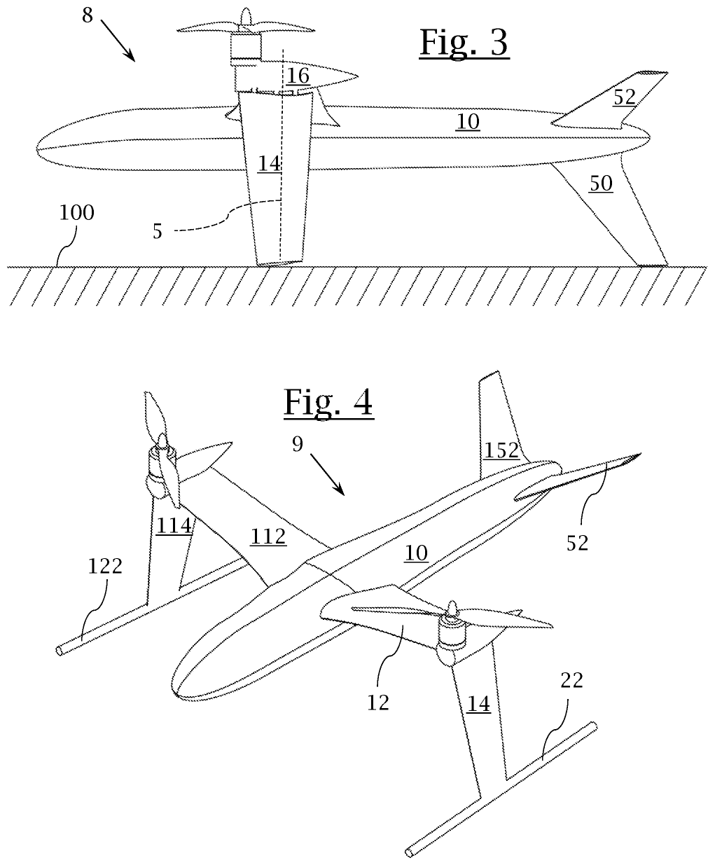

In FIG. 2, outboard wing portions 14 and 114 of the wings are folded downward, the position suitable for vertical flight, hovering, and landing. A side view of aeronautical apparatus 8 is shown in FIG. 3 as it sits on the ground 100. Tips of outboard wing portions 14 and 114 (114 is not visible in FIG. 3) support aeronautical apparatus 8 on ground 100 as well as the tip of vertical stabilizer 50. In some embodiments, the tips of vertical stabilizer 50 and outboard wing portions 14 and 114 are made sufficiently durable to withstand the landing. In other embodiments, landing feet are applied to the tips.

In FIG. 3, outboard wing portion 14 is in the folded state. A dashed line 5 that bisects outboard wing portion 14 is substantially parallel to the geometric plane defined by longitudinal axis 2 and vertical axis 4 (axes are illustrated in FIG. 1). Essentially the plane of the drawing is the plane formed by such axes.

An alternative landing embodiment for an aeronautical apparatus 9 is shown in FIG. 4 in which landing poles 22 and 122 are coupled to the tips of outboard wing portions 14 and 114, respectively. In the embodiment in FIG. 4, aeronautical apparatus 9 relies on the landing poles 22 and 122 to support and balance it on landing. In an alternative embodiment, aeronautical apparatus 9 has a vertical stabilizer 50, such as shown on aeronautical apparatus 8 of FIG. 1. Another embodiment has stabilizer 50 and shorter landing poles than poles 22 and 122 shown in FIG. 4.

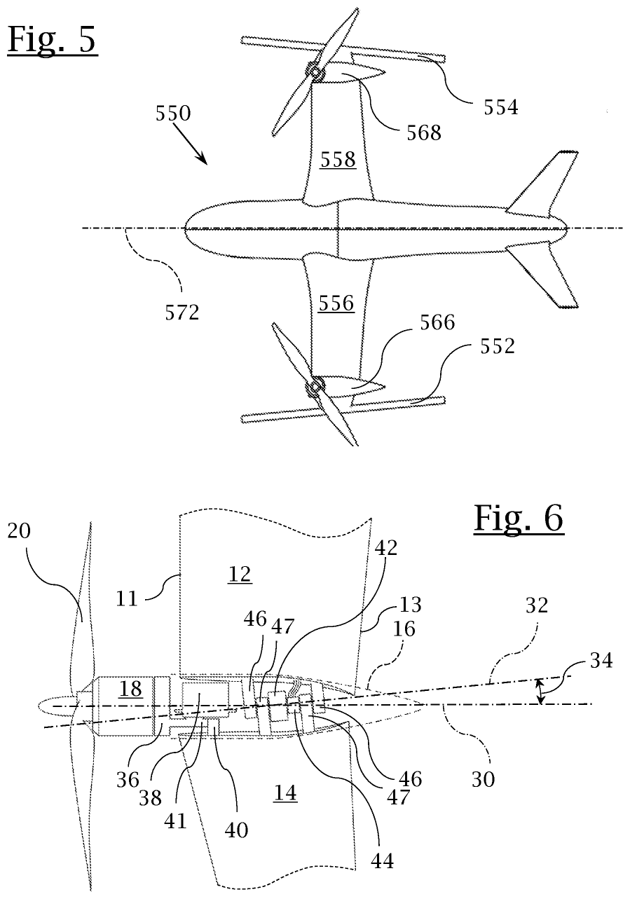

FIG. 5 shows an alternative embodiment of an aeronautical apparatus shown in an overhead view with the wings folded, i.e., in vertical flight or on the ground. Landing poles 552 and 554 are splayed outwardly with the fore portions of landing poles 552 and 554 further away from longitudinal axis 572 of the fuselage than the aft portion of landing poles 552 and 554. Depending on the angle that inboard wing portions 556 and 558 make with longitudinal axis 572 and the angle of the hinges (not shown in FIG. 5) within nacelles 566 and 568, landing poles 552 and 554 are not necessarily parallel when the wings are folded. In other embodiments, landing poles 552 and 554 toe in. It is desirable for landing poles 552 and 554 to be parallel to longitudinal axis 572 when in forward flight. However, in some embodiments, they may be slightly askew from being parallel to longitudinal axis 572.

Landing poles 22 and 122 in FIG. 4 and landing poles 552 and 554 in FIG. 5 are shown with a blunt upstream surface. In alternative embodiments, a structure like the nose cone of the fuselage is attached to the upstream and/or downstream ends of the landing poles to make them more streamline to thereby reduce the drag imposed by the poles.

A section of one of the wings is shown in FIG. 6. Inboard wing portion 12 is at the top of FIG. 6. Recall that inboard wing portion 12 couples to the fuselage (not shown in FIG. 6; would be at the top of the page). An axis of rotation of propeller motor 18 and propeller 20 is shown as axis 30. Axis 30 is parallel to longitudinal axis 2 of aeronautical apparatus 8 (illustrated in FIG. 1). Propeller motor 18 is coupled to a motor mount 36. Motor mount 36 is coupled to a thrust angle motor 38. Nacelle 16 is shown so that the details inside are visible. Hinge portions 46 connected to inboard wing portion 12 and hinge portions 47 connected to outboard wing portion 14 make up a hinge. The hinge has an axis of rotation 32, which is skewed from a vertical plane containing axis 30 by an angle 34. The leading edge of the wing (the wing includes: inboard wing portion 12 and outboard wing portion 14) is at the left in the view of FIG. 6, i.e., the edge closer to propeller 20. Axis 32 is offset from axis 30 such that axis 32 is closer to fuselage 10 at leading edge 11 of inboard wing portion 12 than trailing edge 13 of inboard wing portion 12.

In some embodiments an end of the hinge located at the upstream edge of inboard wing portion 12 is located farther away from a vertical plane containing longitudinal axis 2 of fuselage 10 than an end of the hinge that is located at the downstream edge of inboard wing portion 12. In some embodiments the end of the hinge located at the upstream edge of inboard wing portion 12 is located closer to a horizontal plane below the aeronautical apparatus than the end of the hinge that is located at the downstream edge of inboard wing portion 12. In some embodiments the end of the hinge located at the upstream edge of inboard wing portion 12 is located farther away from the vertical plane containing longitudinal axis 2 of fuselage 10 and closer to the horizontal plane below the aeronautical apparatus than the end of the hinge that is located at the downstream edge of inboard wing portion 12.

In the embodiment in FIG. 6, a rotational damper 42 and a torque adjusting motor 44 are provided between hinge portions 46 and 47. The reason for damper 42 is to avoid rapid changes in the folding and unfolding due to turbulence or other aerodynamic effects that can be jarring. Torque adjusting motor 44 alters the damping effect of damper 42. Some embodiments include only damper 42 and some embodiments include neither damper 42 nor torque adjusting motor 44.

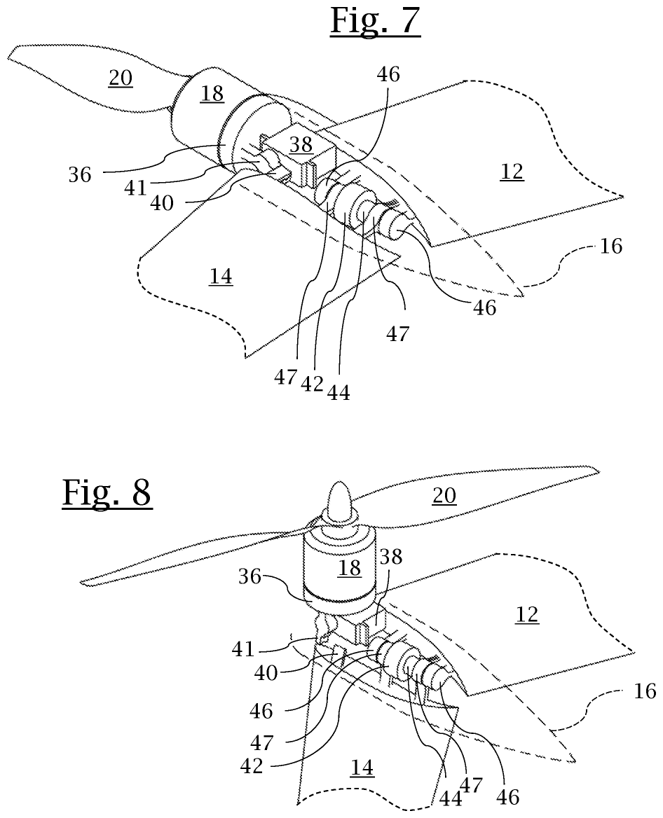

Details of the elements inside nacelle 16 are more readily apparent in isometric views in FIGS. 7 and 8. In FIG. 7, a representation of the unfolded wing with inboard wing portion 12 in line with outboard wing portion 14. Thrust angle motor 38 has rotated propeller motor 18 to the forward flight position. Connections between hinge portions 46 and inboard wing portion 12 and connections between hinge portions 47 and outboard wing portion 14 are apparent in FIG. 7.

In FIG. 8, outboard wing portion 14 points downward, i.e., the folded position. Thrust angle motor 38 has rotated propeller motor 18 to the vertical flight position.

FIGS. 6-8 show a latch, which includes a stop 41 that rotates with propeller motor 18 and a clasp 40 which rotates with outboard wing portion 14. When outboard wing portion 14 unfolds before propeller motor 18 is commanded into the forward flight position, stop 41 goes behind the clasp 40. When propeller motor 18 is in the forward flight position before wing portion 14 unfolds, clasp 40 slips past stop 41 and locks in place. Once propeller motor 18 is fully in the forward flight position, as in FIGS. 6 and 7, clasp 40 is locked into stop 41 so that outboard wing portion 14 cannot refold until propeller motor 18 is commanded to transition to vertical/hover flight mode, as in FIG. 8, stop 41 is rotated down and away from clasp 40 and outboard wing portion 14 is free to move. In an alternative embodiment, such an analogous latching mechanism is employed to hold outboard wing portion 18 in the folded position when the propeller motor is in the landing position.

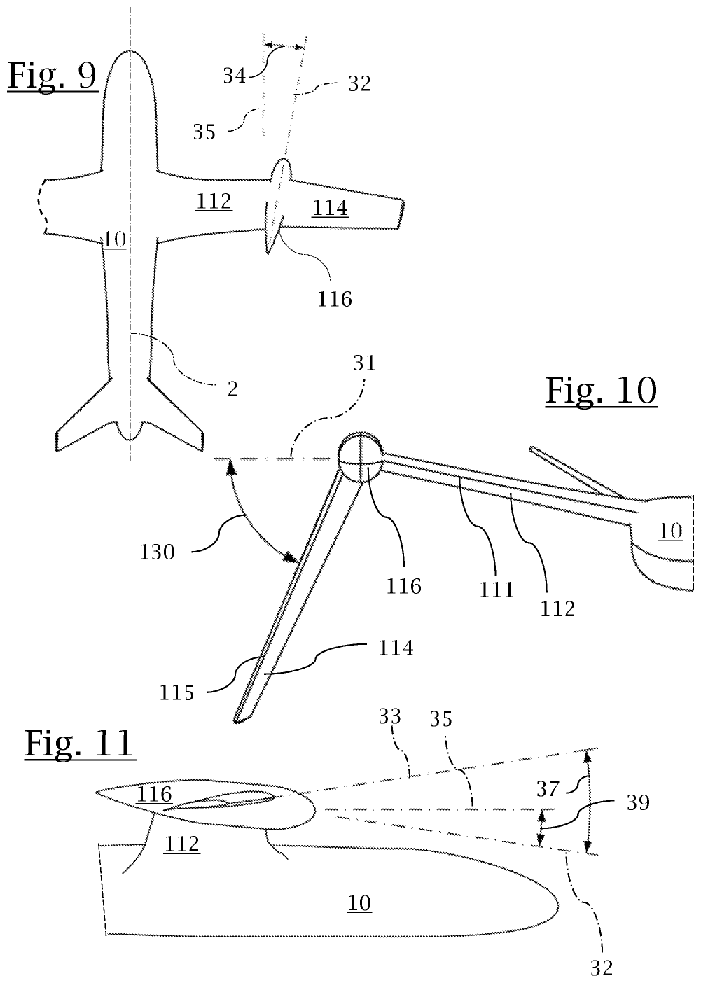

In the embodiments in FIGS. 1-8, the hinge is angled, as shown in FIG. 9. The hinge is in nacelle 116 between outboard wing portion 114 and inboard wing portion 112. The hinge and has an axis of rotation of 32. Axis 35 is parallel to longitudinal axis 2 of FIG. 1. An angle 34 between axes 32 and a vertical plane containing 35 is defined as theta, θ. Referring now to FIG. 10, a portion of fuselage 10 is shown with inboard wing portion 112 connected thereto. Outboard wing portion 114 coupled to inboard wing portion 112 via nacelle 116 in which the hinge is housed. Axis 31 is parallel to lateral axis 6 of FIG. 1 and intersects the hinge axis. Outboard wing portion 114 is partially folded with a fold angle 130 of phi, ϕ, defined as the angle between axis 31 and outboard wing portion 114. Now in FIG. 11, two more angles are defined, angle 37, gamma, γ, which is between axes 33 (extension of the wing chord line of the outboard wing portion) and 32 (hinge axis). Also defined is angle 39, beta, β, which is the angle between axes 32 and a horizontal plane containing 35. Based on this geometry, the angle of attack of the outboard wing portion is determined. Angle of attack, airspeed, air density, and airfoil geometry determine lift force, which for a passive folding wing determines the force acting on the wing to unfold the wing. By angling the hinge axis, the range of airspeeds between the fully folded and fully extended positions is widened, allowing for a slow, controlled transition throughout the conversion corridor.

Another way to look at the passive unfolding is shown in FIG. 10. A leading edge of inboard wing portion 112 is shown. Above leading edge 111 is the upper side of inboard wing portion 112 and below leading edge 111 is the underside of inboard wing portion 112. In regard to outboard wing portion 114, the leading edge 115 is closer to the leftmost part of outboard wing portion 114 (upper side of wing portion) than the right most part of outboard wing portion 114 (underside of wing portion). That is, more of the underside of outboard wing portion 114 is pointing forward than the upper side of outboard wing portion 114. Thus, in forward flight, the underside of outboard wing portion 114 is pointing more toward the flow of air in a manner that forces outboard wing portion 114 to unfold. According to computational fluid dynamic modeling of the aeronautical apparatus, the force generated on outboard wing portion 114 during forward flight is more than sufficient to cause the wing to unfold.

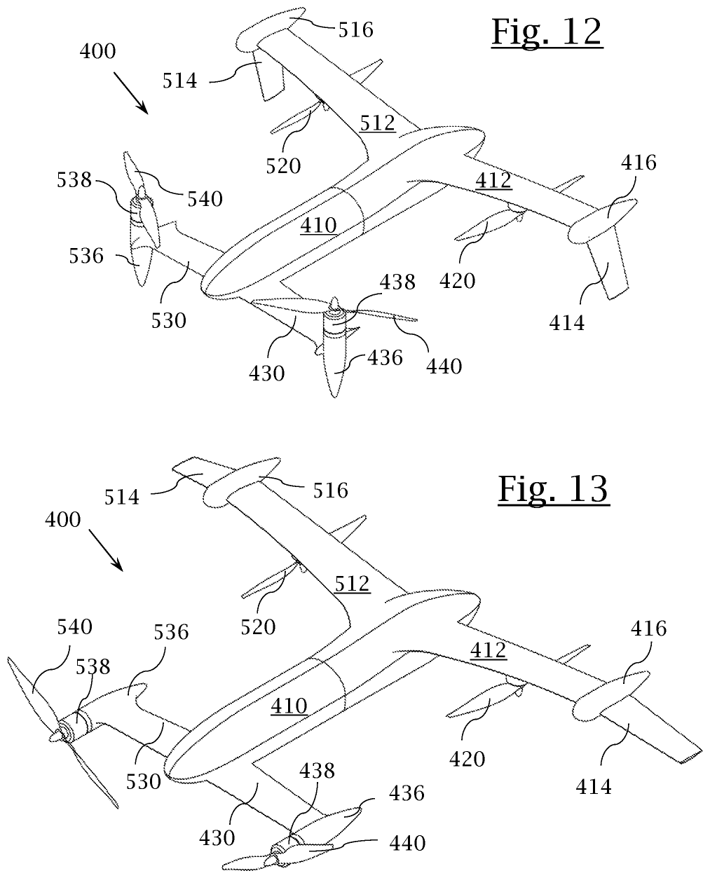

In an alternative embodiment, the folding wings are positioned at the aft of fuselage 410 as shown in FIG. 12 in a vertical flight mode. An aeronautical apparatus 400 in FIG. 12 has fore wings 430 and 530 with nacelles 436 and 536, respectively, located at the tips of wings 430 and 530. Nacelle 436 has a propeller motor 438 and a propeller 440. Nacelle 536 has a propeller motor 538 and a propeller 540. Aft wings include an inboard wing portion 412 and an outboard wing portion 414 on the left side of the aeronautical apparatus and an inboard wing portion 512 and an outboard wing portion 514 on the right side. Inboard wing portion 412 is coupled to outboard wing portion 414 by a nacelle 416; and Inboard wing portion 512 is coupled to outboard wing portion 514 by a nacelle 516. The aft wings are provided propellers 420 on the left and 520 on the right. These wings are fixed such that the thrust angle does not change. The propeller motors associated with propellers 420 and 520 are not visible in FIG. 12. The configuration in FIG. 12 is for vertical flight and all propellers 420, 520, 440, and 540 are employed and outboard wing portions 414 and 514 are folded downward.

In FIG. 13, aeronautical apparatus 400 of FIG. 12 is shown in forward flight. Forward thrust is provided only by propellers 440 and 540. Propellers 420 and 520 remain inactive during forward flight. In some embodiments, they are locked in place; alternatively, they assume the lowest friction position passively. Outboard wing portions 414 and 514 are unfolded so that lift is provided by wings 430 and 530, inboard wing portions 412 and 512, and outboard wing portions 414 and 514. A left thrust angle motor (not visible in FIG. 13) is coupled between wing 430 and nacelle 436. A right thrust angle motor (not visible in FIG. 13) is coupled between wing 530 and nacelle 536.

Although prior embodiments according to the present disclosure have shown passive folding wings, the inventors of the present disclosure have recognized an advantage if the wings are controllable with a motor such as that shown in CN108327906A, although different from the CN108327906A reference because of the skewed hinge angle. Such a situation allows for control of the aircraft and for aerodynamic forces to assist the motor. In FIG. 14, an aeronautical apparatus 600 is shown with a fuselage 610 having a nose cone 602. Fore wings 612 have a propeller motor 620 and propeller 622. Each of the aft wings include an inboard wing portion 614 and an outboard wing portion 616 with a nacelle 626 coupled between the wing portions. Inboard wing portions 614 each have propeller motors (not visible) on the underside with propellers 624 coupled to the propeller motors. Aft wings fold at nacelles 626 which contain hinges (not visible) and motors 628. Motors 628 each have a rod that is coupled to nacelle 614, which in turn is coupled to inboard wing portion 614 and a rod that is coupled to outboard wing portions 616. When actuated, motor 628 causes outboard wing portion 616 to rotate with respect to inboard wing portion 614.

Also shown in FIG. 14 is an electronic control unit (ECU) 650. ECU 650 is provided signals 652 which could be anything from onboard aeronautical apparatus 600 such as position of the folded wing, location, position of aeronautical apparatus 600, battery charge, etc. or environmental, such as temperature, wind speed, barometric pressure, etc. Additionally, a flight mission is assigned to ECU 650 from which a desired trajectory is computed. Alternatively, a user/operator provides information to ECU 650 about a desired trajectory. Based on all the data captured, ECU 650 computes operational information, including: speeds for propeller motors, angle of propeller motors (for propeller motors that change direction via a thrust angle motor), and the motors that control the position of outboard wing portions 616. ECU 650 commands the operational information to the actuators, i.e., the propeller motors, the thrust angle motors, and the motors that control fold angle. ECU 650 can be located onboard the aircraft in the case to facilitate autonomous operation remotely. If ECU 650 is onboard, the communication may be through wires. Otherwise, ECU 650 communicates wirelessly in any manner known to one skilled in the art.

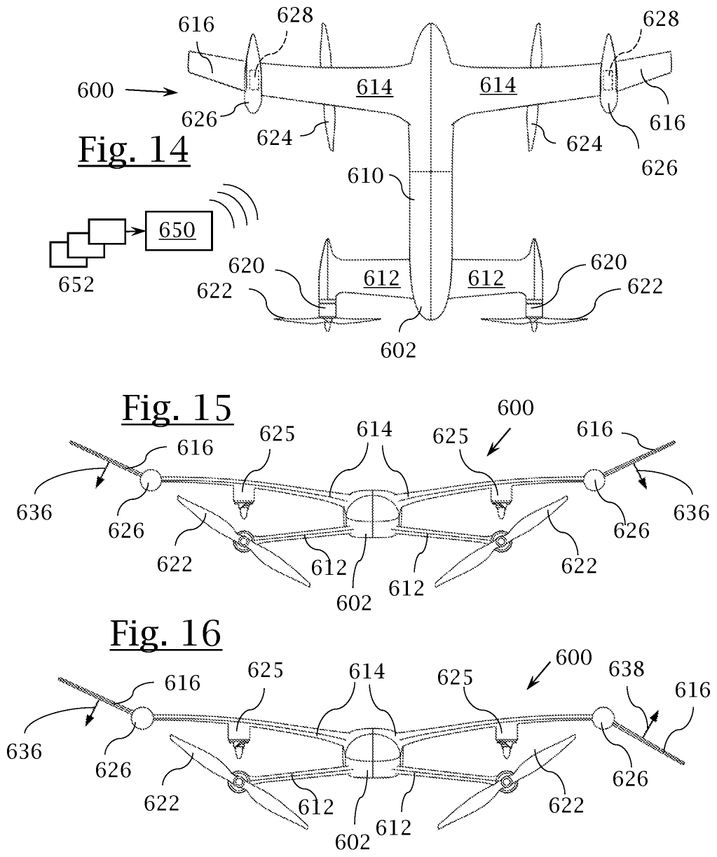

In FIG. 15, aeronautical apparatus 600 is shown in forward flight. A propeller motor 625 is coupled to each aft inboard wing portions 614. Outboard wing portions 616 are shown in positions beyond where they would normally extend passively, due to being actuated by motor 628 (not shown in FIG. 15). This is done to utilize the hinge axis (32 in FIG. 9) being askew from the longitudinal axis (2 in FIG. 1) for the purpose of control in forward flight. The hinge axis has a combination of angles theta, θ (34 in FIG. 9), gamma, γ, and beta, β, (37 and 39 respectively in FIG. 11), such that it is askew from the longitudinal axis. By commanding motor 628 to change the fold angle phi, ϕ(angle 130 in FIG. 10), the angle of attack of outboard wing portions 616 becomes 90°−cos⁻¹(cos γ (sin θ sin ϕ+cos θ cos ϕ sin β)+cos θ cos β sin γ). This relationship can be used to increase, decrease, or reverse a direction of lift produced by the outboard wing portions 616 because angle of attack (along with airspeed, air density, and airfoil geometry) determines lift force. A negative lift 636 is produced by outboard wing portions 616 as motors 628 rotate them past where they would normally extend passively. This results in a nose-up pitch maneuver.

The same aeronautical apparatus shown in FIG. 15 is shown in FIG. 16. One outboard wing portion 616 is rotated up by motor 628 (not shown in FIG. 16), past where it would normally extend passively, producing negative lift 636. The other outboard wing portion 616 is rotated down by motor 628 producing a positive lift 638. This results in a right roll maneuver.

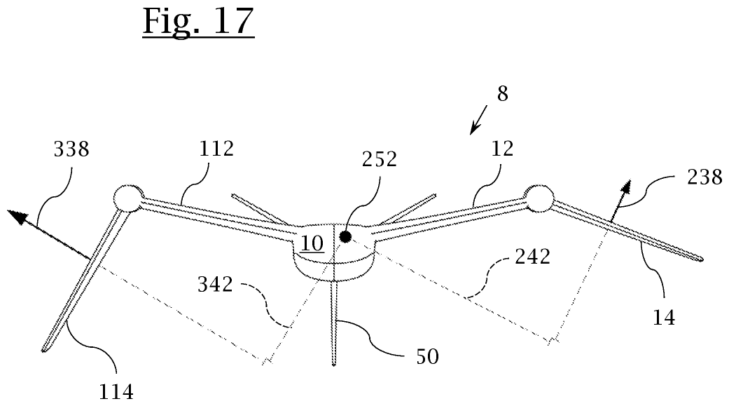

FIG. 17 shows the aeronautical apparatus 7 of FIG. 1 with inboard wing portions 12 and 112 having a dihedral configuration, and outboard wing portions 14 and 114 having asymmetrical fold angles. Aerodynamic forces produced by outboard wing portions, 14 and 114, change based on how much of their respective undersides are facing forward into the stream of air, which, due to their hinge axes (32 in FIG. 6) being askew from the longitudinal axis (2 in FIG. 1), is a function of their respective fold angles (130 in FIG. 10). It is advantageous to have more underside facing forward when outboard wing portions 14 and 114 are in vertical flight/hover position than in forward flight position in the case one side has not unfolded as much as the other, then it will experience greater aerodynamic force and passively reattain symmetrical fold angles. Outboard wing portion 114 is shown having a greater fold angle than outboard wing portion 14 and as a result outboard wing portion 114 experiences a larger aerodynamic force 338 and outboard wing portion 14 experiences a smaller aerodynamic force 238. This causes outboard wing portion 114 to rotate faster about its hinge axis than outboard wing portion 14 and reduce the difference in their respective fold angles. Anhedral or dihedral of the inboard wing portions, 12 and 112, can be used to adjust a lever arm 242 and 342 respectively, by which the aerodynamic forces 238 and 338 of the outboard wing portions, 14 and 114 respectively, produce a torque on a center of gravity 252 of aeronautical apparatus 8. A configuration can be made such that as outboard wing portions 14 and 114 unfold, and the respective aerodynamic forces 238 and 338 decrease, lever arm 242 and 342 increase. Therefore, the overall change in torque (cross-product of force and lever arm) applied to the center of gravity 252 throughout the range of fold angles is minimized. As shown in FIG. 17, aerodynamic force 338 is larger than aerodynamic force 238, but acts on the shorter lever arm 342 than lever arm 242 on which aerodynamic force 238 acts. The net torque on the center of gravity 252 is less with dihedral of the inboard wing portions 12 and 112 than it would be if inboard wing portions 12 and 112 were horizontal. Less net torque is desirable for maintaining stability during transition from hover/vertical flight to forward flight. FIG. 17 shows inboard wing sections 12 and 112 having dihedral, however, some embodiments have anhedral inboard wing sections to best produce this effect.

ECU 650 is illustrated in FIG. 14. However, embodiments in any of FIGS. 1-17 include an ECU for computation and control.

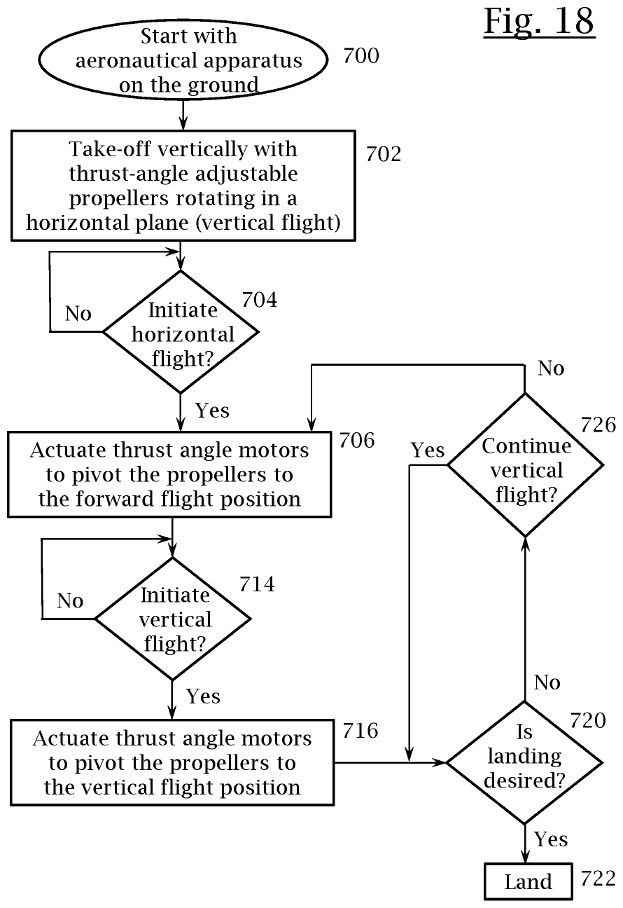

Control of the passive folding wing embodiments is shown in FIG. 18. In block 700, the aeronautical apparatus is on the ground with the outboard wing portions pointing downward. In block 702, when flight is desired, the aeronautical apparatus operation is initiated by starting the propellers to rotate. The propellers are in the position for vertical flight, i.e., with the propeller rotating in a horizontal plane. Control passes to block 704 to determine if horizontal flight is desired. If the aeronautical apparatus hasn't achieved sufficient altitude, a negative result is outputted from block 704. Additionally, if the desire is to hover, a negative result comes out of block 704. Control continues in block 704, until horizontal flight is desired and a positive result is yielded from block 704, which then passes control to block 706. In block 706, the thrust angle motors are actuated to pivot the propellers to the forward flight position. (In some embodiments, the aeronautical apparatus has four propellers, two that are provided by thrust angle motors and two that are not. In that case, the two propeller motors without the capability to be rotated in a forward flight mode are simply shut off once sufficient airspeed has been attained.) When the propellers are moving towards position for forward flight and the aeronautical apparatus starts to accelerate forward, the aerodynamic forces acting on the outboard wing portions cause them to pivot upward to the forward flight position. When the outboard wing portions achieve the fully unfolded position, in embodiments with latches, the latch locks the outboard wing portion into its forward flight position. Control passes now to block 714 in which it is determined whether vertical flight is desired. If not, control stays in block 714 until a positive result, which causes control to pass to block 716. The thrust angle motors are actuated to pivot the propeller into the vertical flight position. Again, in embodiments with a latch, the latch is passively unlatched when the thrust angle motors cause the propeller motor and propeller to move out of the forward flight position. In embodiments with one or more propellers that do not pivot, those fixed propellers are activated for vertical flight as well in block 716. In embodiments with a latch to hold the outboard wing portions in the folded position, they would be latched passively when the outboard wing portions attain the folded position and the propeller motors and propellers are fully in their vertical flight position. Control passes now to block 720 in which it is determine if a landing is requested. If so, landing is accomplished in block 722. If not, control passes to block 726 in which it is determined if a continuation of vertical flying, e.g., hovering, is desired. If yes, control passes back to block 720 to again determine if a landing is desired. If a negative result from block 726, control passes to block 706 to start forward flight.

While the best configuration has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, efficiency, strength, durability, life cycle cost, marketability, speed, endurance, range, appearance, packaging, size, serviceability, weight, manufacturability, ease of assembly, etc. The embodiments described herein that are characterized as less desirable than other embodiments or prior-art implementations with respect to one or more characteristics are not outside the scope of the disclosure and may be desirable for particular applications.

We claim:

1. An aeronautical apparatus, comprising:
a fuselage having a longitudinal axis, a lateral axis and a vertical axis;
a first wing attached to a right side of the fuselage; and
a second wing attached to a left side of the fuselage, wherein:
the first wing has a first inboard wing portion coupled to a first outboard wing portion via a first hinge;
the second wing has a second inboard wing portion coupled to a second outboard wing portion via a second hinge;
the first outboard wing portion folds downward with respect to the first inboard wing portion;
the second outboard wing portion folds downward with respect to the second inboard wing portion;
an axis of rotation of the first hinge is skewed with respect to the longitudinal axis; and
an axis of rotation of the second hinge is skewed with respect to the longitudinal axis of the fuselage.

2. The aeronautical apparatus of claim 1 wherein the first and second hinges are rotationally damped.

3. The aeronautical apparatus of claim 2, further comprising:
a first damper adjacent to the first hinge to provide the rotational damping of the first hinge;
a second damper adjacent to the second hinge to provide the rotational damping of the second hinge;
a first motor adjacent to the first damper; and
a second motor adjacent to the second damper, wherein:
the first motor, when actuated, changes the amount of damping of the first damper; and
the second motor, when actuated, changes the amount of damping of the second damper.

4. The aeronautical apparatus of claim 1, further comprising:
a first nacelle coupled to the inboard portion of the first wing;
a second nacelle coupled to the inboard portion of the second wing;
a first propeller motor disposed within the first nacelle;
a second propeller motor disposed within the second nacelle;
a first propeller coupled to the first propeller motor; and
a second propeller coupled to the second propeller motor.

5. The aeronautical apparatus of claim 4, further comprising:
a third wing on the right side of the fuselage, the third wing being located upstream of the first wing;
a fourth wing on the left side of the fuselage, the fourth wing being located upstream of the second wing;
a third nacelle coupled to the third wing;
a fourth nacelle coupled to the fourth wing;
a third propeller motor disposed within the third nacelle;
a fourth propeller motor disposed within the fourth nacelle;
a third propeller coupled to the third propeller motor; and
a fourth propeller coupled to the fourth propeller motor.

6. The aeronautical apparatus of claim 4, further comprising:
a first thrust angle motor located within the first nacelle and coupled to the first propeller motor; and
a second thrust angle motor located within the second nacelle and coupled to the second propeller motor, wherein: the first and second thrust angle motors each have an axis of rotation roughly parallel to the lateral axis.

7. The aeronautical apparatus of claim 1, further comprising:
a first landing foot located at the tip of the first outboard wing portion;
a second landing foot located at the tip of the second outboard wing portion;
a vertical stabilizer coupled to the fuselage and extending downwardly from the fuselage; and
a landing foot located at the tip of the vertical stabilizer.

8. The aeronautical apparatus of claim 1, further comprising:
a first landing pole connected to a tip of the first outboard wing portion; and
a second landing pole connected to a tip of the second outboard wing portion.

9. The aeronautical apparatus of claim 1, further comprising:
a first propeller motor coupled to the first wing;
a second propeller motor coupled to the second wing;
a first propeller coupled to the first propeller motor;
a second propeller coupled to the second propeller motor;
a third wing coupled to the fuselage on the same side of the fuselage as the inboard wing portion of the first wing; and
a fourth wing coupled to the fuselage on the same side of the fuselage as the inboard wing portion of the second wing, wherein:
the third wing is upstream of the first wing;
the fourth wing is upstream of the second wing;
a first nacelle is coupled to the third wing;
a second nacelle is coupled to the fourth wing;
a first thrust angle motor is disposed within the first nacelle;
a second thrust angle motor is disposed within the second nacelle;
an axis of rotation of the first and second thrust angle motors is substantially parallel with the lateral axis;
a third propeller motor is coupled to the first thrust angle motor;
a fourth propeller motor is coupled to the second thrust angle motor;
a third propeller is coupled to the third propeller motor; and
a fourth propeller is coupled to the fourth propeller motor.

10. The aeronautical apparatus of claim 1 wherein:
the first hinge is constrained to rotate between a first angle and a second angle;
the second hinge is constrained to rotate between a third angle and a fourth angle;
the first angle is when a line through a center of the first outboard wing portion is parallel to a plane formed by the longitudinal and lateral axes;
the second angle is when the line through the center of the first outboard wing portion is parallel to a plane formed by the longitudinal and vertical axes;
the third angle is when a line through a center of the second outboard wing portion is parallel to the plane formed by the longitudinal and lateral axes; and
the fourth angle is when the line through the center of the second outboard wing portion is parallel to the plane formed by the longitudinal and vertical axes.

11. The aeronautical apparatus of claim 10, further comprising:
a first latching mechanism associated with the first hinge to restrain the first outboard wing portion to remain at the first angle during forward flight;
a second latching mechanism associated with the second hinge to restrain the second outboard wing portion to remain at the third angle during forward flight.

12. The aeronautical apparatus of claim 10, further comprising:
a first clasping mechanism associated with the first hinge to restrain the first outboard wing portion to remain at the second angle during landing;
a second clasping mechanism associated with the second hinge to restrain the second outboard wing portion to remain at the fourth angle during landing.

13. The aeronautical apparatus of claim 1 wherein:
the axis of rotation of the first hinge is lower at a leading edge of the first inboard wing portion than a trailing edge of the first inboard wing portion; and
the axis of rotation of the second hinge is lower at a leading edge of the second inboard wing portion than a trailing edge of the second inboard wing portion.

14. The aeronautical apparatus of claim 1 wherein:
the axis of rotation of the first hinge is closer to the fuselage at a trailing edge of the first inboard wing portion than a leading edge of the first inboard wing portion; and
the axis of rotation of the second hinge is closer to the fuselage at a trailing edge of the second inboard wing portion than a leading edge of the second inboard wing portion.

15. The aeronautical apparatus of claim 1, further comprising:
a first motor having a first rod and a second rod; and
a second motor having a third rod and a fourth rod, wherein:
the second rod pivots with respect to the first rod when the first motor is actuated;
the fourth rod pivots with respect to the third rod when the second motor is actuated;
the first rod is coupled to the first inboard wing portion;
the second rod is coupled to the first outboard wing portion;
the third rod is coupled to the second inboard wing portion; and
the fourth rod is coupled to the second outboard wing portion.

16. The aeronautical apparatus of claim 15, further comprising:
an electronic control unit (ECU) configured to communicate signals to the first motor and the second motor wherein:
the ECU determines a desired trajectory of the aeronautical apparatus based at least on user input;
the ECU determines a desired fold angle for each of the first and second outboard wing portions; and
the ECU commands signals to each of the first motor and the second motor to achieve the desired fold angles for each of the first and second outboard wing portions.

17. An aeronautical apparatus, comprising:
a fuselage having a longitudinal axis, a lateral axis and a vertical axis;
a first and a second wing on a right side of the fuselage; and
a third and a fourth wing on a left side of the fuselage, wherein:
the first and third wings are fore wings;
the second and fourth wings are aft wings;
the second wing has a first inboard wing portion coupled to a first outboard wing portion via a first hinge;
the fourth wing has a second inboard wing portion coupled to a second outboard wing portion via a second hinge;
the first hinge allows the first outboard wing portion to pivot with respect to the first inboard wing portion;
the second hinge allows the second outboard wing portion to pivot with respect to the second inboard wing portion;
an axis of rotation of the first hinge is skewed with respect to the longitudinal axis; and
an axis of rotation of the second hinge is skewed with respect to the longitudinal axis.

18. The aeronautical apparatus of claim 17, further comprising:
a first motor having a first rod and a second rod; and
a second motor having a third rod and a fourth rod, wherein:
the second rod pivots with respect to the first rod when the first motor is actuated;
the fourth rod pivots with respect to the third rod when the second motor is actuated;
the first rod is coupled to the first inboard wing portion;
the second rod is coupled to the first outboard wing portion;
the third rod is coupled to the second inboard wing portion; and
the fourth rod is coupled to the second outboard wing portion.

19. The aeronautical apparatus of claim 17, further comprising:
an electronic control unit (ECU) configured to communicate signals to the first motor and the second motor wherein:
the ECU determines a desired trajectory of the aeronautical apparatus based at least on user input;
the ECU determines a desired fold angle for each of the first and second outboard wing portions; and
the ECU commands signals to each of the first motor and the second motor to achieve the desired fold angles for each of the first and second outboard wing portions.

20. The aeronautical apparatus of claim 17, further comprising:
a first landing foot located at the tip of the first outboard wing portion; and
a second landing foot located at the tip of the second outboard wing portion.
